(19) United States
(12) Patent Application Publication
(10) Pub. No.: US 2006/0095298 A1
(43) Pub. Date: May 4, 2006

(54) Method for horizontal integration and research of information of medical records utilizing HIPPA compliant internet protocols, workflow management and static/dynamic processing of information

(76) Inventor: Robert Babak Bina, Towson, MD (US)

Correspondence Address: ROYAL W. CRAIG;A PROFESSIONAL CORPORATION, SUITE 153, 10 NORTH CALVERT STREET, BALTIMORE, MD, 21202, US

(21) Appl. No.: 11/263,580

(22) Filed: Oct. 31, 2005

Related U.S. Application Data
(60) Provisional application No. 60/623,371, filed on Oct. 29, 2004.
(60) Provisional application No. 60/667,868, filed on Apr. 1, 2005.

(51) Int. Cl. G06Q 10/00

(52) U.S. Cl. 705/2

(57) ABSTRACT

A system for management of patient data and simplifying the workflow of attending physicians, residents, nurses, etc. The system is implemented in three software modules: 1) a workflow management module for information entry, manipulation and output (workflow forms management); 2) a query module for data research; and 3) a billing module for medical billing coding. The three modules are constructed atop a foundation comprising a specific relational database design using a segregated static database (containing past day or approved information) and a dynamic database (containing current day unapproved information). The status of dynamic data is changed to static approval by an attending, or lapse of time. The information in the dynamic database is combined with the static to populate a workflow static/dynamic formset including Discharge Summaries, Admission/Daily Notes (with date ranges), Labs, Radiology, Other Information, Prescriptions (Medications filled versus prescribed), and Discharge Orders/Paperwork. This system method more nearly conforms to and automatically fulfills the workflow requirements of attending providers.

### CROSS-REFERENCE TO RELATED APPLICATIONS

The present application derives priority from U.S. Provisional Applications Nos. 60/623,371 filed Oct. 29, 2004, and 60/667,868 filed Apr. 1, 2005.

### BACKGROUND OF THE INVENTION

1. Field of the Invention

The present invention relates to systems and methods for managing health care information and, more specifically, to a business method for horizontal integration and research of information of medical records utilizing HIPPA compliant internet protocols, workflow management and static/dynamic processing of information.

2. Description of the Background

Network technology is designed to share resources that are distributed across a network. However, this can be an elusive goal in the medical context, where doctors and health care providers need a reliable and secure approach to assembling comprehensive patient records from distributed sources. The sources may include multiple provider facilities (clinics and hospitals each of which maintains their own patient database, and each database containing relevant information about a particular patient. However, each database identifies that patient according to a unique identification scheme. Despite the problems, electronic patient records are slowly finding a place in our health care delivery system, largely in response to the demands of the market and governmental policies. This is because on-demand access to such records has potential benefits for all parties inclusive of providers, payors and patients. However, all existing patient record-keeping systems are merely databases for viewing and maintaining records. They help to maintain continuity of care, but in no way facilitate the caregiver's task. Typically, attending physicians, residents, nurses, and other providers need to generate provider-specific forms at every turn, including discharge forms, prescription forms, etc. They must ultimately enter information twice, into the electronic database and into the forms. It would be greatly advantageous to provide a distributed medical information database system that allows all medical information to remain online and retrievable, and which automatically populates the necessary forms in a provider setting such as a hospital.

There have been a few known attempts to provide electronic databases.

U.S. Pat. Nos. 5740428 and 5950207 both issued to Mortimore on Apr. 14, 1998 and Sep. 7, 1999 respectively, disclose a computer based multimedia medical database management system for medical imaging that stores and manipulates multimedia data from various sources and reduces misidentification of data. A unique identifier is generated and linked to each data object at the time the image is generated. U.S. Pat. No. 5146439 issued on Sep. 8, 1992 to Jachmann et al. shows a computer based multimedia medical database management system with a dictation system that receives medical reports and stores them as voice files for later output for review of transcription.

U.S. Pat. No. 5823948 to Ross Jr., et al. issued on Oct. 20, 1998 shows a medical records, documentation, tracking and order entry system that uses video conferencing between a nurse station and a patient station to deliver medical care.

U.S. Patent Application No. 20030177033 issued to Park, Yong-Nam; et al. on Sep. 18, 2003 discloses a method of internet-based medical record database configuration. An object of this invention is to provide an electronic medical record including electronic prescription system etc. based on the internet and implementing method that may rapidly and accurately transmit the electronic medical record including prescription etc. of patient treatment issued by doctor to the other doctor or pharmacist of medical facilities or pharmacy, and connect to the advertising system of pharmaceutical company. This invention comprises: the pharmacy database system; the group server of the membership pharmaceutical; the Web server; the terminal computer group (KIOSK) for payment of medical examination; issuing and transmitting the electronic medical record including slip, prescription etc. according to the result of the medical treatment to the patient-designating medical facilities including pharmacy over Internet after the medical treatment of patient; the terminal of the other medical facilities including pharmacy, and the patient certification database system.

U.S. Patent Application No. 20030120516 issued to Perednia, Douglas A. on Jun. 26, 2003 disclosed an interactive record-keeping system and method. This medical record system has an electronic processing device coupled to a network, a database stored on the electronic processing device, and a form generator for creation of an encounter form corresponding to a set of data fields. A communicator transmits the encounter form via the network to a remote location, the encounter form being structured to receive patient encounter information of a patient encounter at the remote location. A data capture device can electronically capture patient encounter information from the encounter form. The system can schedule events and monitor compliance therewith. As well, an interactive medical consent curator can create a consent form corresponding to a medical procedure. User inputs can be received and a session recorder employed to record a consent session.

In addition to the cited patents, there is PatientKeeper®(See http://www.patientkeeper.com/). PatientKeeper is a patient management software tool deployed on PDA's and handhelds. Over 50,000 physicians already use the PatientKeeper solution to capture and sort patient information such as admission diagnoses, patient histories, daily progress notes, and lab results, medications being taken by patients at home and in the hospital, and even alarms for reminders. PatientKeeper relies predominantly on pop-up lists, check-boxes, and multiple-choice items to enable data entry. However, the specific information collected can only be printed for inclusion in reports or medical charts.

Also, MEDITECH offers a full range of software applications for health care facilities; these software applications are called the Health Care Information System (HCIS) (See http://www.meditech.com/). HCIS is offered on both a Microsoft®Windows®based Client/Server platform and on a platform using their own MAGIC operating systems. MEDITECH offers the ability to review and process orders all from one portal, ability to utilize one routine for processing all patient and order types, immediate access to lab results associated with the medications being ordered/reviewed, ability to combine medications, dosages, and directions into standard order sets, access to the patient's electronic medical record right from the desktop, ability to compile reports and statistics from the same work area, ability for users to access their customized desktops from any network device as well as remotely, and access to customizable menus based on responsibilities to streamline workflow. MEDITECH also offers numerous other applications including pharmacy, patient care management, ambulatory, health information management, etc.

ChartMaxx™supports the creation and management of an electronic patient record. (See http://www.medplus.com/products-services/chartmaxx_product-software.htm.) The major software components of ChartMaxx include: ChartMaxx/MR (includes completion workflow, billing system, and the ability to print/fax electronic charts along with a customizable cover letter and invoice), ChartMaxx/Clinician, and ChartMaxx/PA (includes patient accounts workflow). ChartMaxx is a client/server application that supports both Windows and Web-based clients. ChartMaxx brings together patient clinical and financial data resident on multiple systems and combines that data with paper originated documentation captured through scanning. The result is a multi-media data repository that provides an integrated view of patient clinical and financial information. ChartMaxx provides application functionality specifically targeted for clinicians, the Health Information Management department, and the Patient Accounts department. In addition to managing patient-oriented data, ChartMaxx can also manage administrative or non-patient oriented data, such as monthly financial reports and human resources data.

While the prior art medical systems described above try to facilitate patient-physician interactions, or make data more readily available over networks, none facilitate the workflow of attending physicians, residents or nurses as required at each interaction within a given care facility.

It would be greatly advantageous to provide attending physicians, residents and nurses with a unified distributed medical database management system designed to facilitate the normal workflow of providers, in which information is entered by the physician during an inpatient admission and thereafter by all attending physicians, residents, nurses, etc., said information Populating specific workflow forms including admission H&Ps, initial orders, Medicine Schedules (MARs), Daily SOAP notes (attending provider notes), preliminary discharge summaries, daily sign-outs, printed scripts, discharge paperwork, etc., thereby simplifying the workflow of providers.

### SUMMARY OF THE INVENTION

It is therefore an object of the present invention to provide a business method for horizontal integration and research of information of medical records utilizing HIPPA compliant internet protocols, workflow management and static/dynamic processing of information.

It is another object to provide a unified patient record workflow system for entry and management of patient data, and specifically for simplifying the workflow of attending physicians, residents, technicians and nurses.

It is another object to provide a unified patient record workflow system by which patient information is entered by the physician during an inpatient admission and at all visitations there after, whereby the system generates current standardized forms during the normal workflow of patient-physician interactions (Admission H&P, Orders, MAR, Daily SOAP note, preliminary discharge summary, daily sign-out, printed scripts, discharge paperwork, demographic information, consults).

It is still another object to make physician workflow data more readily available over distributed networks.

It is still another object to provide a prescription network with the ability to send prescriptions electronically to subscribing pharmacies and, when dispensed, the prescriptions are scanned and added to the patient's medical record for safety tracking.

It is still another object to provide a revenue model that includes 1) income from provider subscriptions to the web-based services, plus 2) third party subscriptions to use the data as a research tool, plus 3) a percentage of sales of medicines subscribed using the present system, plus 4) advertising income on web-site by pharmaceutical companies, etc.

The system is maintained on a network architecture comprising an information server running a relational database, and workflow management software. The database is segregated into a static database (containing past day or approved information) and a dynamic database (containing current day unapproved information). The information in the dynamic database is combined with the static to populate a hybrid static/dynamic formset including Discharge Summaries, Admission/Daily Notes (with date ranges), Labs, Radiology, Other Information, Prescriptions (Medications filled versus prescribed), and Discharge Orders/Paperwork. The status of dynamic data is changed to static upon the first-to-occur of: 1) approval of an authorized healthcare provider (which is generally any physician); or 2) passage of calendar day, whichever occurs first. Moreover, dynamic data displayed on the formset is distinguished from static in some way, as is approved versus unapproved static data.

The workflow management software includes a number of different features or “modules”: 1) a workflow management module that allows information entry, manipulation and output specifically for workflow forms management, including prescriptions; 2) a query module for allowing third party data research; 3) a billing module for medical billing coding; and 4) a pharmacy module for directly interfacing with pharmacies to track and execute prescription orders. The modules are constructed atop a foundation comprising a specific relational database design coupled with a simple user interface that allows direct data entry and forms generation by attending physicians and nurses. The system is enabled on a 3rd party server and is provided to a health provider's physicians for data entry and viewing by client terminals or PDAs. Revenue will come from a combination of subscribing providers, subscribing pharmacies, subscribing researchers, and contracted research. Specifically, at least four revenue streams are presently envisioned:

Revenue stream 1: Provider subscriptions to the Workflow and patient information database for entry and management of patient data and simplifying the workflow of their attending physicians, residents, nurses, etc..

Revenue stream 2: Pharmacy subscribers and commission from medication sales.

Revenue stream 3: Subscription to the Research database (outside firms who wish to research the unified patient Research database.

Revenue stream 4: Research we do on contract for other firms/entities upon request using the Research database.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a network diagram illustrating the use of Information Server 40 according to the present invention.

FIG. 2 is a flow diagram of the business method.

FIG. 3 is a flow diagram of the method for managing health care information according to the present invention.

FIG. 4 is a screen print of the program Start Page illustrating the workflow management user interface.

FIG. 5 is a screen print of the History & Physical Exam page.

FIG. 6 is a screen print of an Admission Medication Order.

FIG. 7 is a screen print of the Daily Soap Note Form.

FIG. 8 is a screen print of the Sign Out Form.

FIG. 9 is a screen print of the Discharge Order.

FIG. 10 is a screen print of the Prescription Orders database.

FIG. 11 is a field mapping of the tables of the present database, inclusive of all fields and relationships.

### DETAILED DESCRIPTION OF THE PREFERRED EMBODIMENT

The present invention is a system for horizontal integration and research of information of medical records utilizing HIPPA compliant internet protocols, workflow management and static/dynamic processing of information. The method may be incorporated in any distributed architecture and relies on an independent and secure third party Information Server 40 capable of acting as a central web-enabled database server. The Information Server 40 may be a conventional network server that includes resident software for administering the present method, and a storage medium for storing information about participants in health care transactions. These participants may include, but not be limited to one or more patients, physicians, other health care providers, hospitals and clinics, and employees thereof.

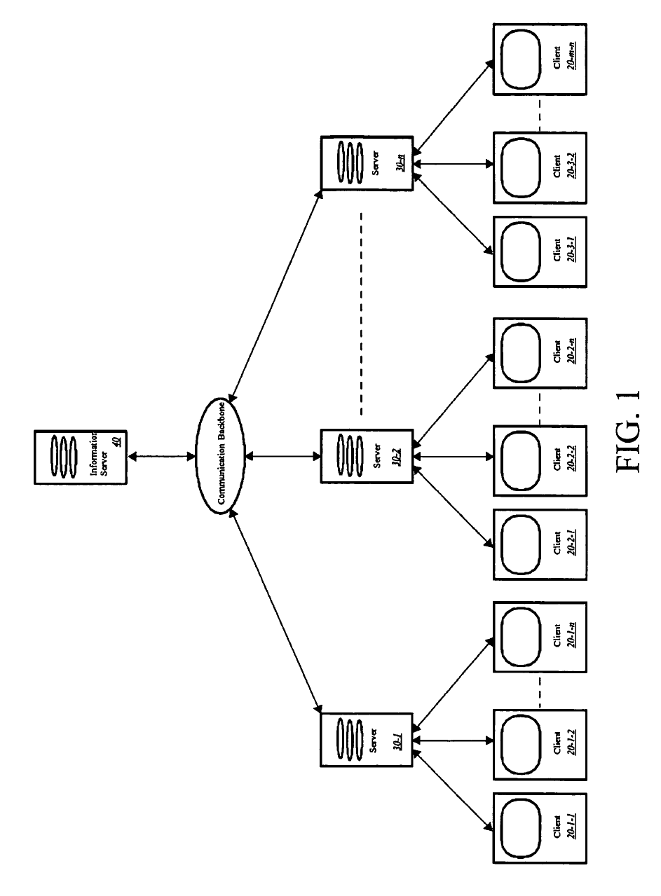

The architecture of FIG. 1 may additionally include any number of distributed client network servers 30-1 . . . n, supporting networks such as, for instance, a hospital network, diagnostic laboratory network, local practicing physician network, etc. All distributed client networks 30-1 . . . n are connected via a communication backbone such as the internet (or alternatively, satellite, ATM, etc.). Similarly, the Information Server 40 is also connected via the communication backbone and serves to implement and administer the present method. A plurality of client terminals 20-1-1 . . . n may be connected to each client network 30-1 . . . n as shown to enable individual physicians, residents, technicians, nurses and, when appropriate, patients to access the present system. The client terminals 20-1-1 . . . n may be conventional personal computers, web enabled telephones, personal digital assistants (PDAs), or like devices.

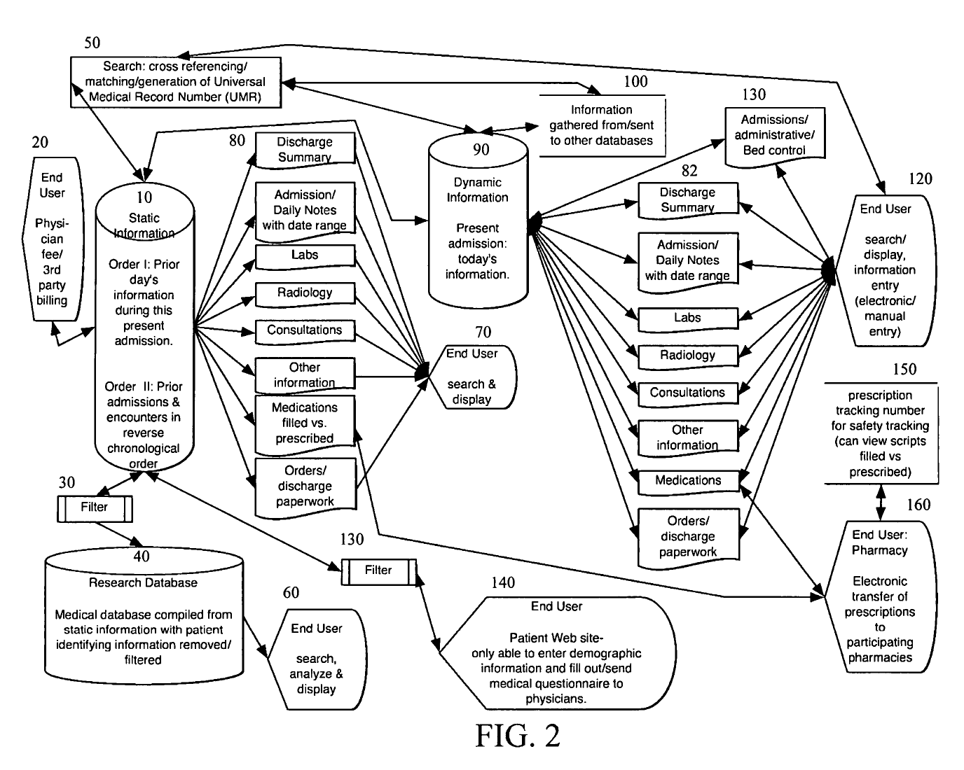

FIG. 2 is a flow diagram of the business method according to the present invention. The Information server 40 of FIG. 1 stores Static Information 10, which includes two static records of data that are compiled for each newly admitted patient: Order I (prior day's information for the patient admission); Order II (prior admissions and encounters, in reverse chronological order). Each patient record added to the Static Information 10 is tagged with a unique Universal Medical Record Number (UMR) at 50 to allow cross-platform referencing/matching/searching by UMR. Subscribing physicians, hospitals and other providers may access the Static Information at 20 by keying in any particulars including the UMR, which culls all matching records tagged by that UMR. The Static Information 10 data records for Orders I and II are filtered of personal information at 30 to construct a separate anonymous record for research purposes at 40. This Research Database 40 is a medical database compiled from the static information with patient identifying information removed/filtered, and this research database 40 may be accessed by researcher-subscribers at 60 who wish to search, analyze & display statistical analyses of the filtered research database 40.

The data records for Orders I and II are also filtered of sensitive diagnosis information at 130 and are made available in filtered form to patients via a web site at 140. This patient information 140 may be accessed by patients who may enter or complete additional demographic information or send electronic questions/questionnaires to their physicians. Physicians can also provide the patient with an online display of laboratory test results, bypassing the need to call a physician to obtain the actual results of the test. The liaison provides an online display that specifies whether a health care provider has viewed and cleared the test results as normal/abnormal, ensuring that abnormal results do not slip through the cracks. Moreover, abnormal results are reported to the physician immediately via electronic means. Commercial advertisements are also displayed to the patient, and the revenue from the advertisements is directed back to the subscribing provider, thereby allowing them to be compensated for online ads.

To simplify workflow for all attending care providers, the Static Information 10 data records for Orders I and II are used to populate a specific library of editable forms at 80 (and as described below), including Discharge Summaries, Admission/Daily Notes (with date ranges), Labs, Radiology, Other Information, Prescriptions (Medications filled versus prescribed), and Discharge Orders/Paperwork. Any subscribed End Users may at 70 search, display and, subject to defined user rights, edit the forms 80. This component of the system greatly simplifies the workflow of attending physicians, residents, technicians and nurses by automatically generating standardized forms needed during specific patient-provider interactions. Forms 80 include Discharge Summaries, Admission/Daily Soap Notes (with date ranges), Labs, Radiology, Other Information, Prescriptions (Medications filled versus prescribed), and Discharge Orders/Paperwork. Admission H&P, Orders, and MAR forms.

In addition to the static information 10, a dynamic database 90 is maintained. The records/fields in the dynamic database 90 match those of the static 10, but dynamic database 90 stores the current daily admission information. The current information in the dynamic database 90 may be collected from the immediate provider as well as other remote databases of other providers at 100. This dynamic information 90 is combined with the Static Information 10 to populate a hybrid static/dynamic formset 82 that likewise includes Discharge Summaries, Admission/Daily Notes (with date ranges), Labs, Radiology, Other Information, Prescriptions (Medications filled versus prescribed), and Discharge Orders/Paperwork. Subscribing End Users at 120 may search and display the hybrid static/dynamic formset 82.

In accordance with the present invention, the status of dynamic data (ref 10 in FIG. 2) is changed to static (ref. 90 in FIG. 2) upon the first-to-occur of: 1) approval of an authorized healthcare provider (which is generally any physician); or 2) passage of a predetermined amount of time, preferably at change of calendar day, whichever occurs first. All dynamic data displayed on the formset is preferably distinguished from static in some way such as by shading, coloration, italics, etc. In addition, all dynamic data that has matured from static data by passage of time (and has therefore not been approved) is preferably distinguished from approved dynamic information in some way such as by shading, coloration, italics, etc. This feature of the present method more nearly conforms and automatically fulfills the workflow requirements of attending providers.

Moreover, form control is more accurate. Each prescribed medication entered into Medication Form at 80 is tagged with a unique prescription tracking number at 150 for safe-tracking, which can be electronically communicated to subscribing pharmacies at 160. Both pharmacies and physicians can conveniently transfer and manage prescriptions in this manner, and readily view prescription scripts that were filled as well as unfilled but prescribed.

Moreover, the patient has the ability to request refills of prescriptions online, and can determine whether prescriptions are available for pickup, by browsing online. More importantly, the pharmacy can automatically perform a textual analysis of the medical records provided by the physician and automatically order the drugs prescribed, bypassing the need for a error-prone handwritten prescriptions.

The benefits of the above-described system for providers include improved information flow, improved patient safety, reduced administrative costs, utilization review, fewer long distance telephone calls, increased customer satisfaction, etc. The cost of healthcare is reduced due to the multiple benefits of improved information flow and data integration both within a hospital and across healthcare facilities and other healthcare related entities, potentially decreased hospitalizations and clinic visits, and improved inpatient and outpatient safety, etc. In addition, underwriting data will improve due to increased data collection: physician practice patterns, prescriptions, tests, etc. Most importantly, the patient outcome will improve thanks to preventative health management, and reduced drug errors and interactions.

The software for implementing the above-described workflow management method generally comprises three modules: 1) a workflow management module that allows information entry, manipulation and output specifically for workflow management of the static formset 80 and hybrid static/dynamic formset 82; 2) a query module for allowing data research; and 3) a billing module for medical billing coding. The three modules are hosted at the Information Server 40 and facilitate the specific relational database design (with separate static database 10 and dynamic database 90) via a simple user interface that allow direct data entry and forms 180 generation.

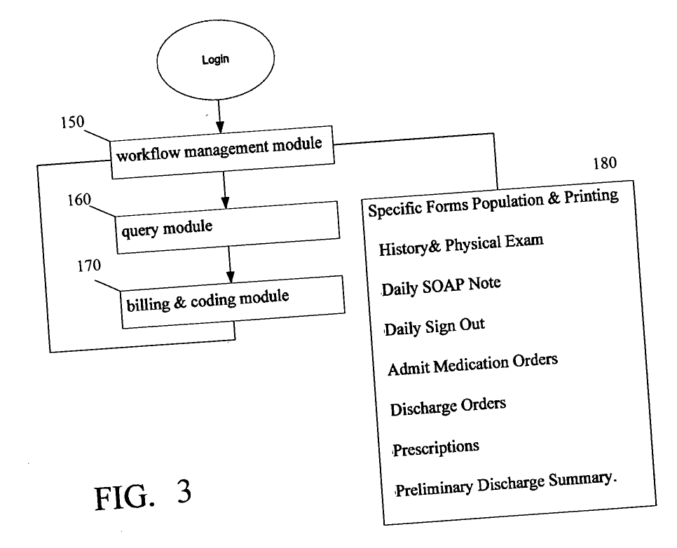

FIG. 3 is a conceptual diagram of the workflow management method according to the present invention, inclusive of the three implementing modules. The workflow management module 150 provides a graphical user interface that allows information entry, manipulation and output specifically for workflow forms management, the specific forms being listed at right and detailed below. The system also presents an SQL query module 160 with graphical interface for allowing data research on the previously-entered data. Finally, the method includes a billing module 170 for medical billing coding. All three modules 150-170 derive data from the separate static database 10 and dynamic database 90 as described, and the interface may be authored using conventional database authoring software, preferably, but not limited to, Filemaker®version 8 or higher. Access to the program requires a username and authorized password.

The three modules of the present software as well as the database layout are described in detail below.

1. Workflow Management Module 150

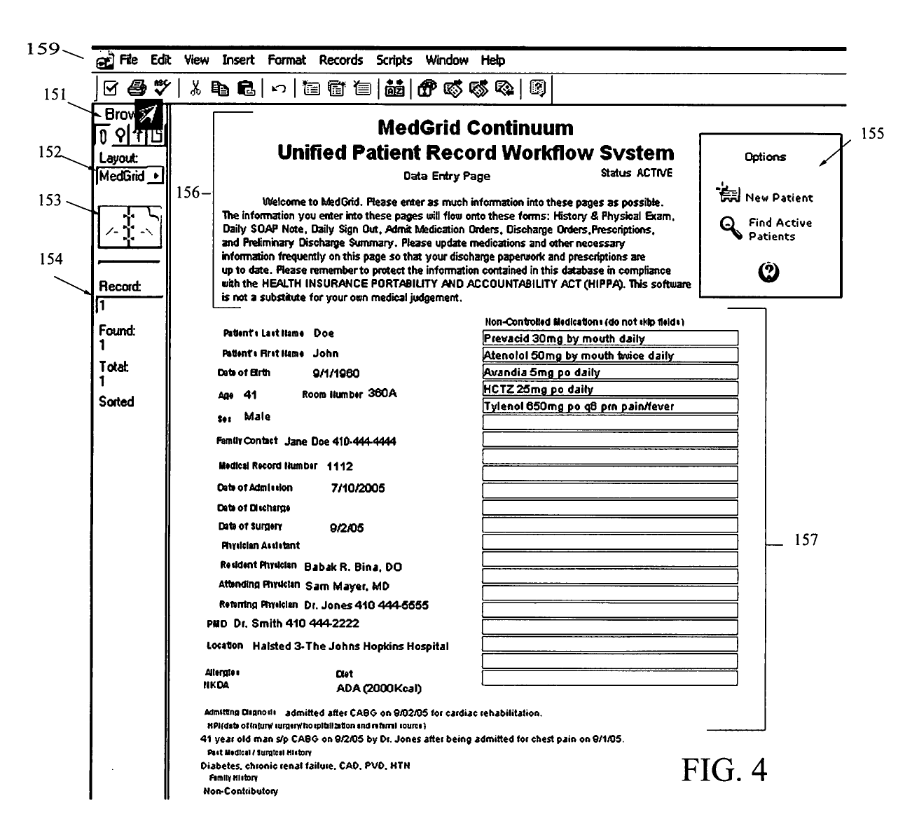

FIG. 4 is a screen print of the program Start Page illustrating the workflow management user interface. The interface is framed in a standard Microsoft Windows or Apple MacIntosh operating system environment which, in the exemplary Windows XP environment shown in FIG. 4 includes a standardized command bar at top with a file navigation menu and selected graphical shortcuts.

The program presents its own navigation menu at top left, which includes Browse controls 151, a Layout Selector 152, a Page Navigator 153, a text menu of commands 159, and a Record Display 154. The Browse controls 151 control the content and layout of a form display field (at right) which generally includes a fixed introductory information field 156 followed by a Data Entry Page 157. The initial introductory information field 156 offers a welcome and introductory information for completing the forms, advising to enter as much information as possible. The information shown on the Data Entry Page 157 includes fields for the patient's Name, Date of Birth, Age, Room Number, Sex, Family Contact, Medical Record Number, Date of Admission, Date of Discharge (if discharged), Date of Surgery, and attending caregivers including Physician's Assistant, Resident Physician, Attending Physician, and Referring Physician, and Patient Location. This is followed by Medication and Diet information inclusive of all Controlled Medications (Advair 500/50, Atenolol 12.5 mg, Prevacid 30 mg, etc.), Admitting Diagnosis, HPI, Past Medical History, Family History, Social History. The admitting diagnosis and notes are displayed at the bottom. All the information shown on the Data Entry Page 157 is collected from the relational database described above that is used to populate a series of editable forms selectable via the Layout Selector 152. The Layout Selector 152 allows a choice between a specific library of forms for completion by attending physicians, residents and nurses at each caregiver transaction. In accordance with the present method, workflow is simplified by selecting the specific needed transaction paperwork by choosing the corresponding form under the Layout Selector 152 menu. This done, all information entered in the Data entry page 157 will flow onto the forms as appropriate. A change in a piece of information on any form carries over and is made automatically on all forms. The specific array of forms selectable via the Layout Selector 152 includes the following: License Agreement, Using MedGrid Continuum, Census, MedGrid Data Entry Page, History & Physical Exam, Admission Medication Orders, Daily SOAP Note, Daily Sign Out, Nursing Report, Discharge Orders, Printed Prescriptions, Discharge Summary, Interdisciplinary Questionnaire, and Vital Signs Board.

For each selected form, the Data Entry Page 157 assimilates preexisting data from the database and presents it in the tabular form of fully editable data fields framed by a formatted form in portable document format. Adobe's Portable Document Format (PDF) is currently the open standard for electronic document distribution. PDF is a universal file format that preserves all of the fonts, formats, images, graphics, and color of any source document no matter what application and platform was used to create it. A PDF file always displays exactly as created, even if created by a foreign software application, operating system or platform. PDF files can be published and distributed anywhere. The entire library of portable document forms is stored in its entirety on the database. The forms may be stored in binary (not text) format, such for instance using Base64 encoding (a,MIME encoding that maps binary data), hex encoding (where each binary octet is encoded using two characters representing hexadecimal digits), or unparsed entities (where the binary data is stored in a separate physical entity from the data used to populate the data fields).

Thus, as the data fields are populated and/or edited the data updates medications and other necessary information on all forms so that all discharge paperwork and prescriptions are up to date. Requisite warnings are provided to protect the information contained in this database in compliance with the Health Insurance Portability and Accountability Act (HIPPA).

A shortcut 155 (top right) is also provided to provide one-click access to certain records-management commands such as “New Patient” (open a new patient record), find patient, print page and help.

The text menu of commands 159 includes a series of drop-down command trees with the following categories: File, Edit, View, Insert, Format, Scripts, Window, Help. These are standard Windows-based commands, the Record category allowing navigation and operations on records in the database, inclusive of the following: Duplicate Record, Show All Records, Show Omitted Only, Omit Record (from current view), Omit Multiple, Modify Last Find, Sort Records, Unsort, Replace Field Contents, Relookup Field Contents, Revert Record. It is important to note that once a record has been created and saved it cannot be deleted.

The Browse controls 151 control the display of these fields and data entry, the pencil icon allowing direct data entry, the magnifier icon allowing searching by text or numbers to find matching records, the arrow returning the cursor to the first field, and the creased page displaying a print preview for printing of the form.

The Page Navigator 153 simply turns the form page.

The Record Display 154 allows form selection from among the following forms: License Agreement, Using MedGrid Continuum, Census, MedGrid Data Entry Page, History & Physical Exam, Admission Medication Orders, Daily SOAP Note, Daily Sign Out, Nursing report, Discharge Orders, Printed Prescriptions, Discharge Summary, Interdisciplinary Questionnaire, and Vital Signs Board.

The License Agreement for selection will display the user license agreement, and the Using MedGrid Continuum selection will display a user help dialog. The Census selection will display a summary of patient information including name, Medical Record Number, and attending physician.

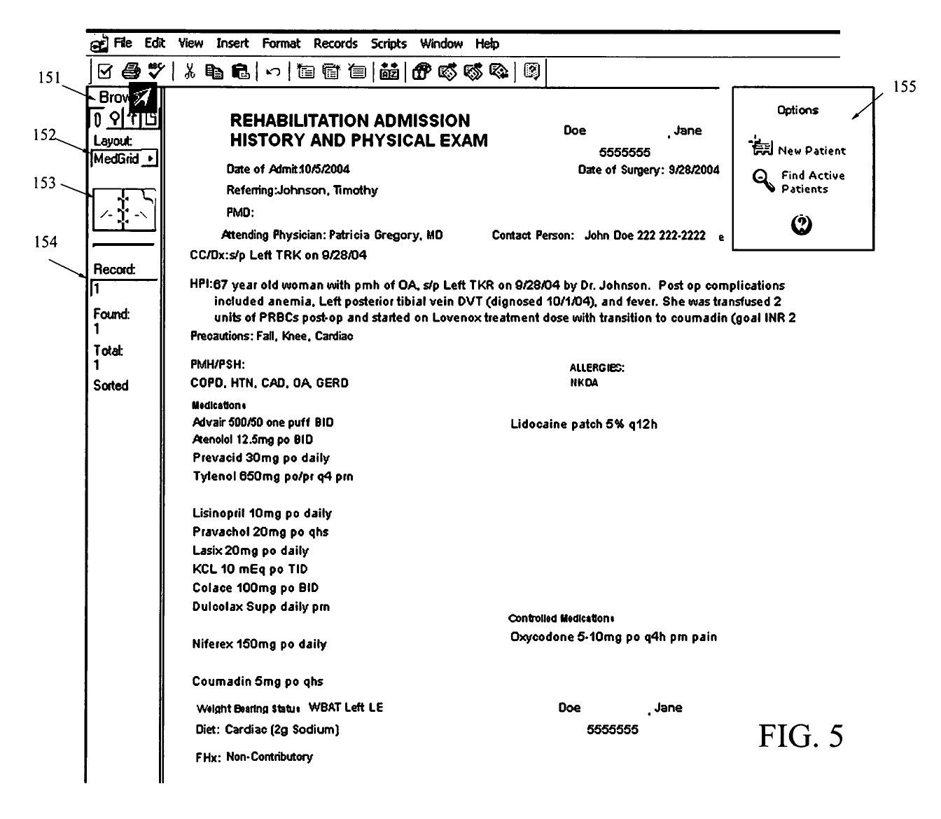

FIG. 5 is a screen print of the History & Physical Exam page, which includes fields for Name, Date of Admit, Date of Surgery, Referring Physician, Attending Physician, Contact Person, and Historical entries, e.g, HP1: “67 year old woman with pmh of OA, s/p Left TKR on 9128/04 by Dr. Johnson. Post op complications included anemia. Left posterior tibial vein DVT (dignosed 1011104), and fever. She was transfused 2 units of PRBCs post-op and started on Lovenox treatment dose with transition to coumadin (goal INR 2-3).” Also listed are Precautions, Patient Medication History (PMH/PSH), Allergies, and related historical information.

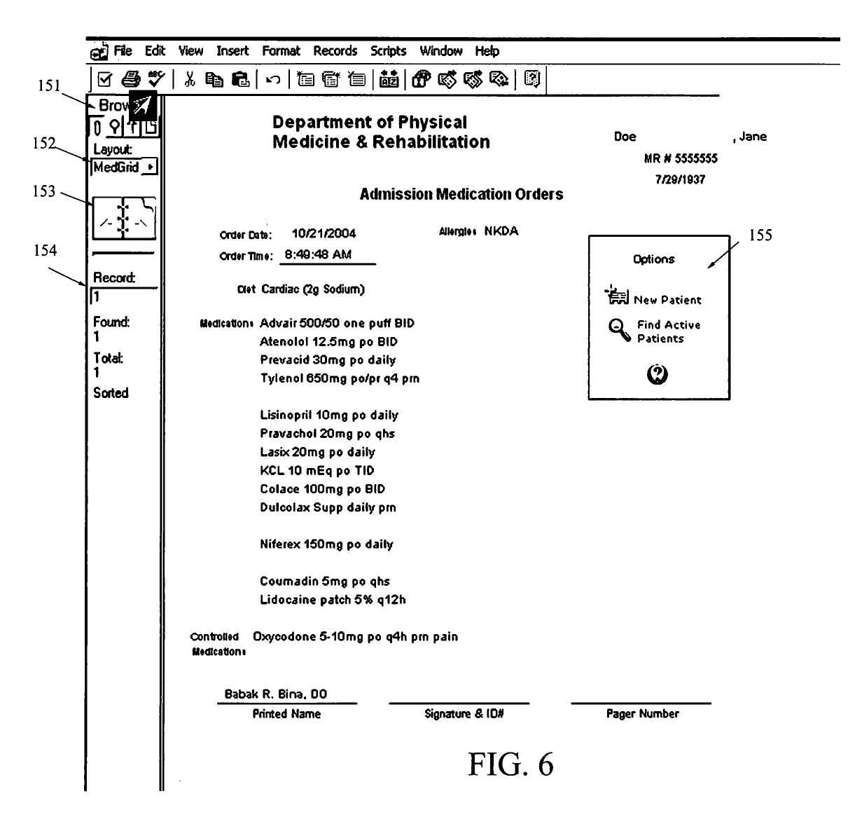

FIG. 6 is a screen print of an Admission Medication Order, which includes Name, Order Number (MR#), Order Date, Order Time, Allergies, a Listing of the Ordered Medications (Advair500150 one puff BID, Atenolol 12.5 mg po BID, Prevacid 30 mg po daily, etc.) and the ordering physician complete with signature block (Printed Name, signature & IDN, and pager number).

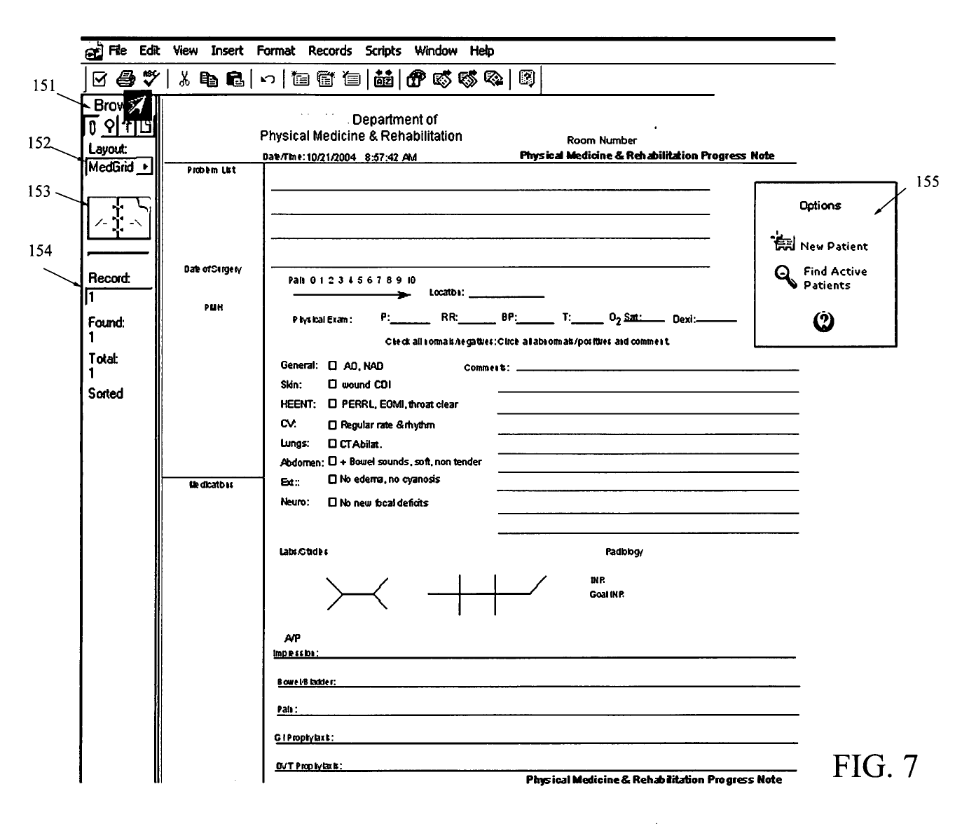

FIG. 7 is a screen print of the Daily Soap Note Form, which attendings must complete at each transaction when making rounds. The generation of this standardized form during the normal workflow residents greatly simplifies their workload.

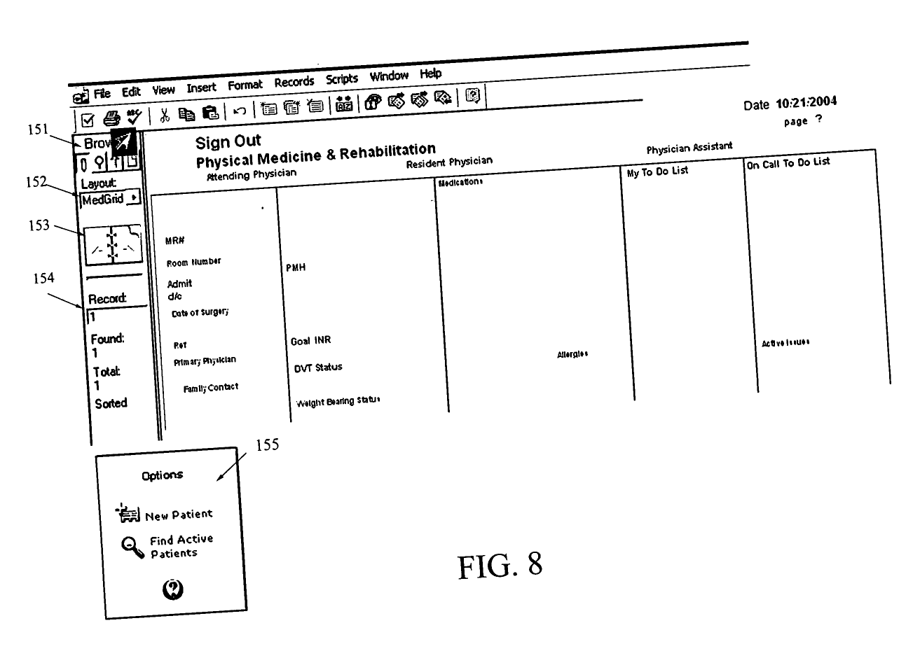

FIG. 8 is a screen print of the Sign Out Form, which attendings or residents must complete when signing out. As described previously, the open book icon 153 (at left) parses through the various patient records, and the corresponding Sign-Out Forms are automatically generated (yet modifiable) with editable “My to do” field and “On call to do” field. Changes on this form will change equivalent fields on other forms directly. Thus, if the on call team or physician changes medications, it will reflect in the rest of the patient's forms in the database. A preview of the completed form can be viewed by clicking the preview mode icon (the rightmost single-page icon under the Browse menu controls at top left). This form greatly reduces the time to make a sign-out that is accurate (compared to paper forms which might otherwise take an hour to complete by hand and are prone to error attributable to poor handwriting.

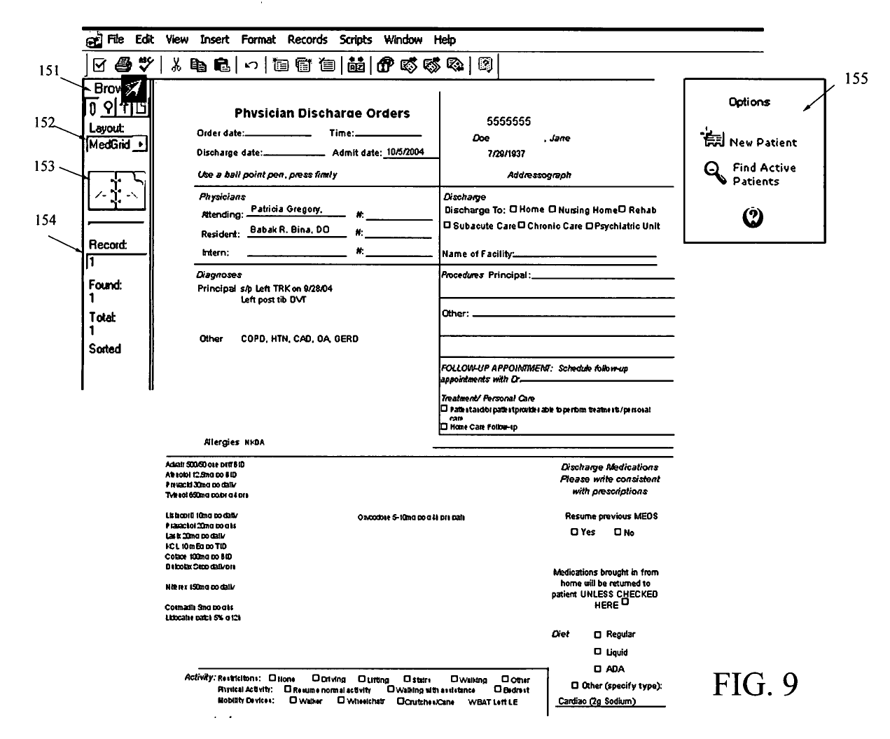

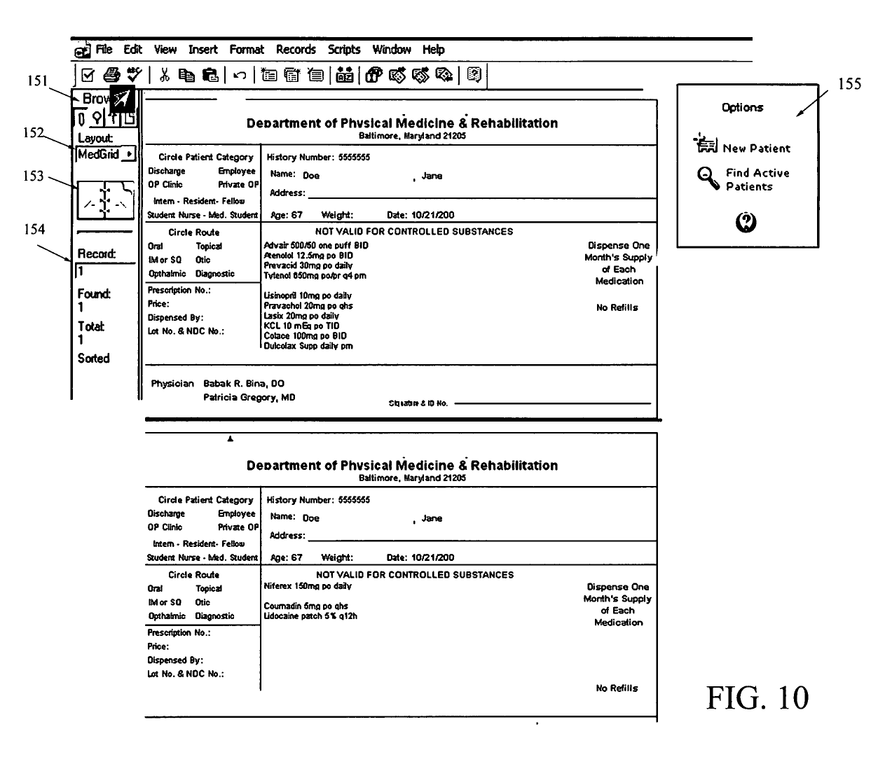

FIG. 9 is a screen print of the Discharge Order which attendings must complete to discharge a patient. It is also possible to view prior Discharge Summaries which consolidate the information on prior Discharge Orders in report format.

FIG. 10 is a screen print of the Prescription Orders which may be printed directly to prescribe medications. The Prescription includes Patient Information, Patient Category, and all necessary medication information inclusive of Delivery Route, Prescription No., Price, Dispensed By, Month's Supply of Each Medication, as well as the prescribing physicians and signature blocks. Once printed, a Prescription Order can be presented directly to a pharmacy by the patient. A Unified Prescription form can also be generated as a report of all ordered prescriptions.

The Record Display 40 also allows form selection of Admission Medication Orders, Medicine Schedules (MARs), Nursing Reports, Interdisciplinary Questionnaires, and Vital Signs Boards (not shown).

2. SQL query module 160 with graphical interface for data research An SQL query module 160 provides a graphical interface to allow the user to easily construct extensive SQL database queries. Users may also EDIT the SQL queries created by this tool and run them against the entire database. The user can search by any field or combination of fields in the database. For example, the user may want to search from lowest to highest room number (sign-outs, SOAP notes, etc will print in order of room number). Searches can be generated by age, sorted from lowest age to oldest patient. Searches can isolate which patients have diabetes, etc. Combination queries can be constructed, for example, the user may query how many people have diabetes, are male and have had a stroke. Any combination of multiple criteria allows the user to narrow down what they are looking for.

3. Billing module 170 for medical billing coding

Referring back to FIG. 3, a billing module 170 is for medical billing coding which gleans information from each of the static and dynamic databases 10, 90 and condenses them into a collective reimbursement claim form for submission to the appropriate payer. The system automatically assimilates all necessary tracking data from the consultations, electronic forms, and clinical data collection steps into a bundled service reimbursement request which may be submitted automatically and electronically.

4. Database Layout

As stated above, static information 10 is segregated from dynamic information 90, and this may be by separate databases, records or servers. The data in the dynamic database 90 matches that of the static 10, but dynamic database 90 stores the current daily admission information. Both sets of data (static 10 and dynamic 90) are arranged in four relational tables.

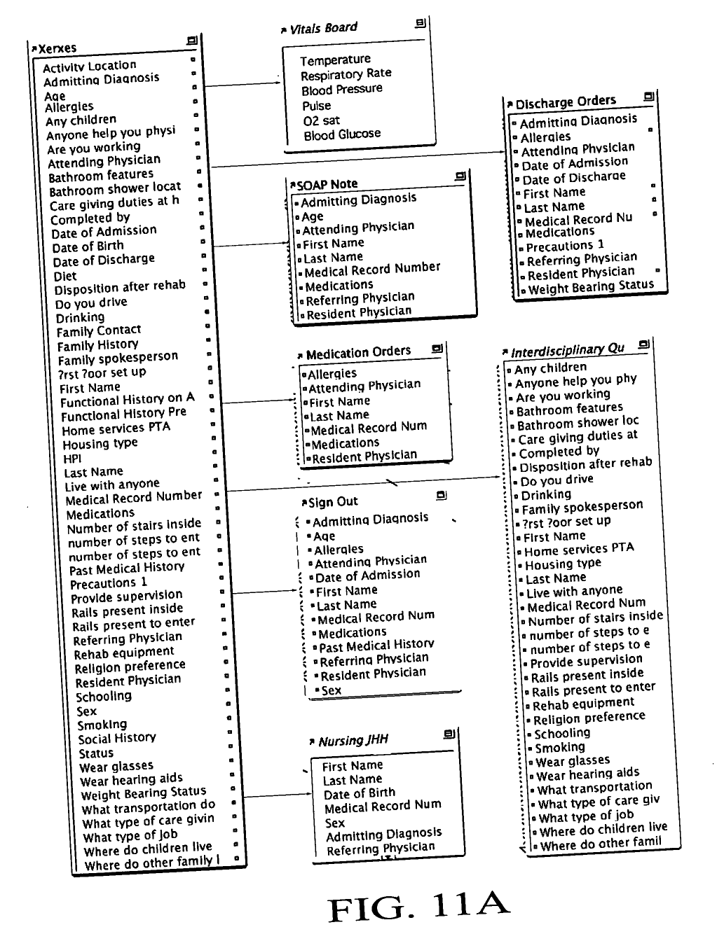

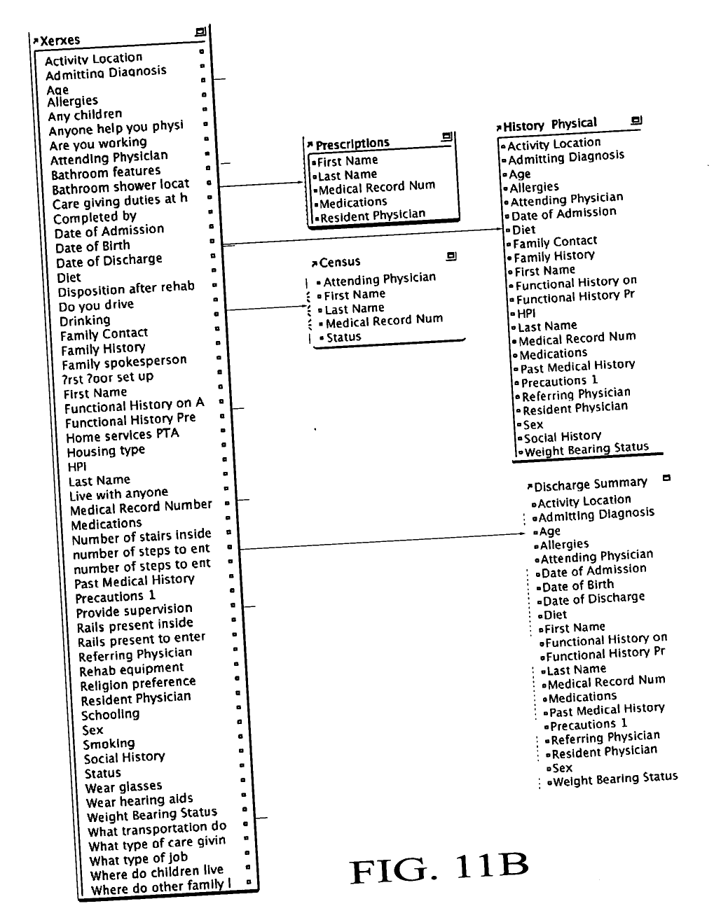

The primary table, entitled Xerxes, currently requires 317 fields, and this table (including all fields and relationships) is mapped to the others in FIG. 11 (A & B). In addition, there are separate tables for Nursing, Signout, and Vitals Board.

The Nursing table is a compilation of data used by nurses in their Nursing reports, inclusive of First Name, Last Name, Date of Birth, Medical Record Number, Sex, Admitting diagnosis, Referring Physician, etc.

The Signout record is a compilation of data needed for the attending's daily sign-out, including the patient's Admitting Diagnosis, Age, Allergies, Attending Physician, Date of Admission, First Name, Last Name, Medial Record Number, Medications, Past Medical History, Referring Physician, Resident Physician, and Sex, etc.

The Vitals Board is a chronological record of vital signs taken by the provider, including Temperature, Respiratory Rate, Blood Pressure, Pulse, D2 sat, and Blood Glucose, etc.

The three foregoing tables are linked to the primary Xerxes table and derive certain data fields there from.

The remaining forms are derived entirely of fields from the Xerxes, Nursing, Signout, and/or Vitals Board tables and are completely compiled by queries (no separate record need by maintained). These include the Daily Soap Notes, Medication Orders, Discharge Orders, Interdisciplinary Questionairre, Prescriptions, Census, History Physical, and Discharge Summary. These queries compile data from the other tables (including all fields from Xerxes) as shown in the mapping of FIGS. 11A & B.

Note that if one related field is changed in one form, all forms change as well. This particular database layout allows ready population of the forms from the database, in a more exhaustive manner (the Sign-Out Form provides a very complete view of the patient . . . one that is often not obtained with traditional paper sign-outs).

5. Business Model

As detailed above, the present system is preferably enabled on a 3rd party server 40 (FIG. 1) and is provided to a health provider's physicians for data entry and viewing by client terminals or PDAs. Revenue will come from a combination of subscribing providers, subscribing pharmacies, subscribing researchers, and contracted research. Specifically, at least four revenue streams are presently envisioned:

Revenue stream 1: Provider subscriptions to the Workflow and patient information database for entry and management of patient data and simplifying the workflow of their attending physicians, residents, nurses, etc.

Revenue stream 2: Pharmacy subscribers and commission from medication sales.

Revenue stream 3: Subscription to the Research database (outside firms who wish to research the unified patient Research database.

Revenue stream 4: Research we do on contract for other firms/entities upon request using the Research database.

It should now be apparent that the above-described system is a unified patient record workflow system for entry, management and use of patient data, and specifically for simplifying the workflow of attending physicians, residents, nurses, and other providers. The simplified data entry and forms generation features along save hours per day.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

I claim:

1. A method for workflow management in a healthcare provider setting by maintaining separate static and dynamic information, comprising the steps of:
providing health care providers with a workflow management user interface including,
a patient data entry form, and
a form selector allowing selective display and editing of a library of patient transaction forms including any one from among a group consisting of a History & Physical Exam, Admission Medication Order, Daily SOAP Note, Daily Sign Out, Nursing Report, Discharge Orders, Printed Prescriptions, and Discharge Summary;
identifying data entered onto any one of said forms as dynamic data; and
changing the identification of said dynamic data to static data upon first-to-occur of approval by an authorized healthcare provider or passage of a predetermined period of time; and
assimilating preexisting data from the database and displaying said data graphically in context on any one of said library of patient transaction forms with dynamic data indicated thereon.

2. The method for workflow management in a healthcare provider setting by maintaining separate static and dynamic information according to claim 1, wherein each of said library of patient transaction forms are displayed in portable document format with editable text fields.

3. The method for workflow management in a healthcare provider setting according to claim 1, wherein said dynamic data is distinguished from static data when displayed on said library of patient transaction forms by any one of shading, coloration and italics.

4. The method for workflow management in a healthcare provider setting according to claim 3, wherein dynamic data that has matured from static data by passage of a predetermined period of time is distinguished from approved dynamic information by any one of shading, coloration and italics.

5. The method for workflow management in a healthcare provider setting by maintaining separate static and dynamic information according to claim 1, wherein said predetermined period of time comprises change of calendar day.

6. The method for workflow management in a healthcare provider setting by maintaining separate static and dynamic information according to claim 1, wherein said step of providing health care providers with a workflow management user interface further comprises a query module for allowing data research on said static and dynamic data.

7. The method for workflow management in a healthcare provider setting by maintaining separate static and dynamic information according to claim 6, wherein said query module further comprises an SQL query module with graphical interface for allowing data research.

8. The method for workflow management in a healthcare provider setting by maintaining separate static and dynamic information according to claim 1, wherein said step of providing health care providers with a workflow management user interface further comprises a billing module for medical billing coding.

9. The method for workflow management in a healthcare provider setting by maintaining separate static and dynamic information according to claim 1, wherein said library of patient transaction forms additionally includes an Interdisciplinary Questionnaire, and Vital Signs Board.

10. The method for workflow management in a healthcare provider setting by maintaining separate static and dynamic information according to claim 9, wherein said library of patient transaction forms additionally includes a License Agreement, Help, and general Data Entry Page.

11. A system for workflow management in a healthcare provider setting comprising:
a application service provider (ASP) server system for dynamically storing patient information entered by a healthcare provider;
an SQL data server for populating a first SQL database with the dynamic data, and for populating a second SQL database by moving said dynamic data therein as static data upon first-to-occur of acceptance by an authorized healthcare provider or passage of a predetermined period of time; and
a library of portable document transaction forms stored in binary in the SQL database;
whereby data is assimilated from said first and second SQL databases and is displayed graphically in context of said library of patient transaction forms with dynamic data indicated thereon.

12. The system for workflow management in a healthcare provider setting according to claim 9, wherein each of said library of patient transaction forms are displayed in portable document format with editable text fields.

13. The system for workflow management in a healthcare provider setting according to claim 11, wherein said predetermined period of time comprises change of calendar day.

14. The system for workflow management in a healthcare provider setting according to claim 11, further comprising an SQL query module for allowing data research on said static and dynamic data.

15. The system for workflow management in a healthcare provider setting according to claim 14, wherein said SQL query module with graphical interface for allowing data research.

16. The system for workflow management in a healthcare provider setting according to claim 11, further comprising a billing module for medical billing coding.

17. The system for workflow management in a healthcare provider setting according to claim 11, wherein said portable document transaction forms include any one from among a group consisting of a History & Physical Exam, Admission Medication Order, Daily SOAP Note, Daily Sign Out, Nursing Report, Discharge Orders, Printed Prescriptions, and Discharge Summary.

18. The system for workflow management in a healthcare provider setting according to claim 17, wherein said portable document transaction forms additionally include an Interdisciplinary Questionnaire, and Vital Signs Board.

19. The system for workflow management in a healthcare provider setting according to claim 18, wherein said portable document transaction forms additionally includes a License Agreement, Help, and general Data Entry Page.

20. A method for third party operation of a unified patient record workflow system for entry and management of patient data, and simplifying the workflow of attending physicians, residents, nurses and other providers, comprising a network architecture including an information server running a relational database, and software including a workflow management module comprising a graphical user interface for allowing information entry, manipulation and output specifically for workflow forms management; a query module for allowing data research; and a billing module for medical billing coding.
